(19) United States
(12) Patent Application Publication
(10) Pub. No.: US 2020/0309250 A1
(43) Pub. Date: Oct. 1, 2020

(54) GEARBOX WITH FLOW GUIDING STRUCTURE

(71) Applicant: Fairway Electronic Co., Ltd., New Taipei City (TW)

(72) Inventors: Lin-Han YEN, New Taipei City (TW); Chien-Hsiung HSIEH, New Taipei City (TW)

(21) Appl. No.: 16/563,049

(22) Filed: Sep. 6, 2019

(30) Foreign Application Priority Data
Mar. 28, 2019 (TW) 108203791

(51) Int. Cl. F16H 57/04; F16H 37/04; F16H 57/029; F16H 1/16; F16H 1/28; F16H 57/039

(52) U.S. Cl. CPC F16H 57/0498; F16H 37/041; F16H 57/029; F16H 1/16; F16H 2057/02008; F16H 57/039; F16H 57/0421; F16H 57/0486; F16H 2702/02; F16H 1/28

(57) ABSTRACT

A gearbox with flow guiding structure comprises a box and an oil retaining ring. The box has a gear set configured inside. The gear set comprises a worm and an epicyclic gear set engaged with the worm. The box comprises an upper casing and a lower casing. The upper casing is disposed on the lower casing. An oil retaining wall is disposed on the bottom of the upper casing. The oil retaining wall is disposed inside the lower casing sidewall when the upper casing is engaged with the lower casing, and is disposed around the epicyclic gear set. The oil retaining ring is disposed around the epicyclic gear set. The outer side wall of the oil retaining ring has a curvature.

### RELATED APPLICATIONS

The present application claims the priority of Taiwan Application No. 108203791, filed Mar. 28, 2019, the disclosure of which is hereby incorporated by reference herein in its entirety.

### BACKGROUND OF THE INVENTION

### 1. Field of the Invention

The present disclosure generally relates to a gearbox with flow guiding structure, and, more particularly, to a gearbox capable of circulating the lubricant inside the gearbox while the gear set is operating.

### 2. Description of the Related Art

Main transmission components inside a handheld machine tool contains a motor and a gearbox that connects the motor. In general, a small amount of the lubricant on the gear set in the gearbox is used to reduce the drag generated by the gear set driven by the motor in the gearbox for the purpose of less wear so as to reduce the temperature rise and power consumption, and to increase the rotating speed of the motor to promote the output power of the handheld machine tool.

However, the lubricant between the gear sets is easily thrown off if the motor speed is too high. It decrease the effect of the addition of lubricant greatly. If more lubricant is added for this purpose, it is easy to increase the resistance or drag of the gear set during operation due to excessive lubricant. It causes more power consumption and cannot effectively reduce the temperature rise.

Therefore, how to improve the internal structure of the current gearbox is a problem still to be solved in the industry to allow the lubricant inside the box to circulate effectively while the gear is operating, to maintain the amount of lubricant between the gear and not to be thrown off when the gear is operating.

### SUMMARY OF THE INVENTION

The present inventive concept provides a gearbox with flow guiding structure, comprising: a box having a gear set configured inside, the gear set comprising a worm and an epicyclic gear set engaged with the worm; an oil retaining wall disposed inside the box and surrounding the epicyclic gear set; and an oil retaining ring disposed around the epicyclic gear set, the outer side wall of the oil retaining ring having a curvature.

In an exemplary embodiment, the box comprises an upper casing and a lower casing, and the oil retaining wall is connected to the bottom of the upper casing.

In an exemplary embodiment, the upper edge of an inner side of the oil retaining wall has a curvature at the position connected to the upper casing.

In an exemplary embodiment, the box comprises a first space and a second space, the first space is used to accommodate the worm and the second space is used to accommodate the epicyclic gear set.

In an exemplary embodiment, the box further comprises a partition wall and the first space comprises a first accommodating portion and a second accommodating portion, wherein the partition wall is disposed in the first space inside the box, the partition wall separates the first space to form the first accommodating portion and the second accommodating portion.

In an exemplary embodiment, the gearbox further comprises an alignment groove disposed at the bottom of the upper casing, wherein the alignment groove is in contact with some of the components of the epicyclic gear set.

In an exemplary embodiment, the gearbox further comprises a first convex portion disposed at the bottom of the upper casing and around the alignment groove, and disposed on an inner side of the oil retaining wall.

In an exemplary embodiment, the epicyclic gear set comprises the worm gear, a sun gear, a plurality of outer gears and a carrier, the sun gear is coaxial with the worm gear, the worm gear is engaged with the worm, the sun gear and the plurality of outer gears are assembled on the carrier and is engaged with each other, and the oil retaining ring is surrounding the epicyclic gear set.

In an exemplary embodiment, the carrier has a center pillar and a plurality of peripheral pillars disposed around the center pillar, the plurality of outer gears are respectively set on the peripheral pillars, the sun gear and the worm gear are set on the center pillar, and the center pillar is against the alignment groove when the upper casing is engaged with the lower casing.

In an exemplary embodiment, the gearbox with flow guiding structure further comprises a fixing part disposed in the second accommodating portion, the fixing part is used to fix the components of the motor.

In an exemplary embodiment, the oil retaining wall, the oil retaining ring and the first convex portion form a flow space for circulating a fluid.

In an exemplary embodiment, the oil retaining ring is an annular gasket made of rubber.

Compared to prior art, a gearbox with flow guiding structure according to the present inventive concept is able to guide the flow of the lubricant inside the box during the operation of the gear set, and to keep the lubricant in the space where the gear operates. Even if the lubricant is thrown off due to the operation of the gear, it can flow back between the gears via the guide structure of the design according to the present inventive concept. This allows the lubricant effectively play its role and reduces the resistance when the gear is operating.

### BRIEF DESCRIPTION OF THE DRAFLAPS

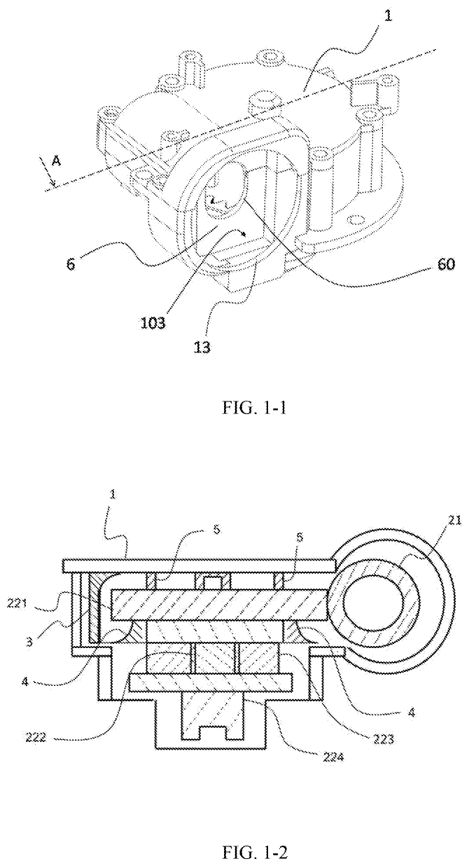

FIG. 1-1 is a schematic view of the external structure of the gearbox with flow guiding structure according to the present inventive concept;

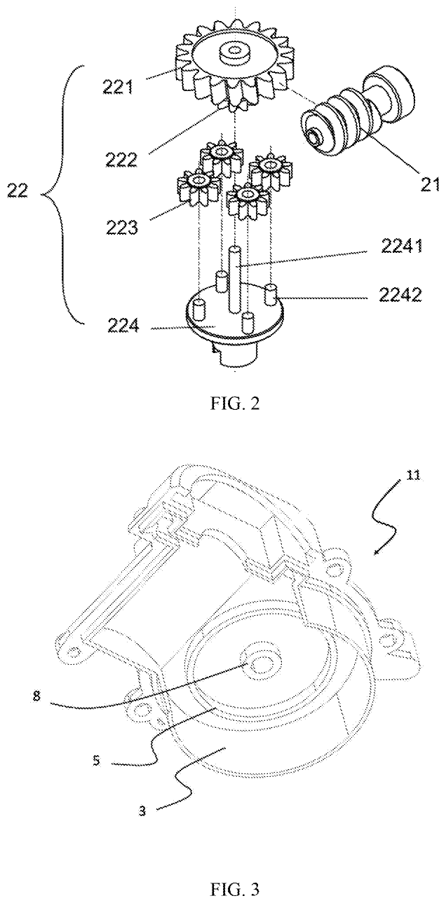

FIG. 1-2 is a structural cross-sectional view of direction A in FIG. 1-1;

FIG. 2 is a schematic view of the gear set inside the gearbox with flow guiding structure according to the present inventive concept;

FIG. 3 is a structural schematic view of the upper casing;

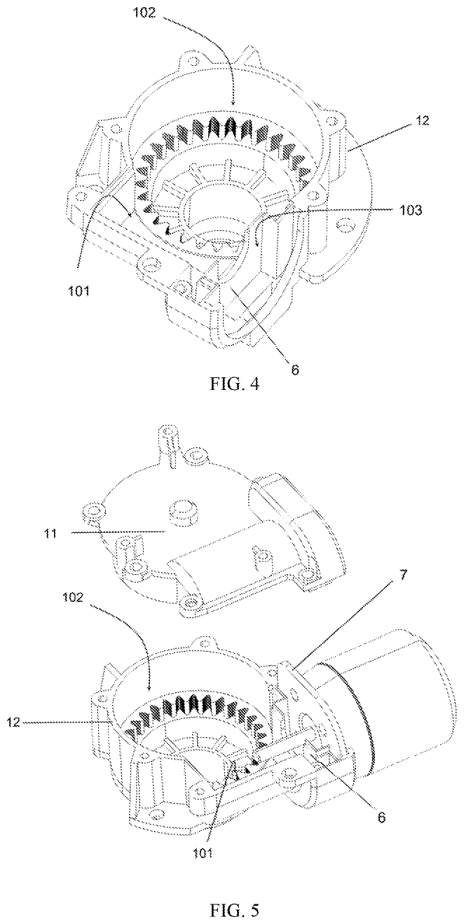

FIG. 4 is a structural schematic view of the lower casing; and

FIG. 5 is a schematic view of the gearbox combined with the motor.

### DETAILED DESCRIPTION

The present inventive concept is described by the following specific embodiments. Those with ordinary skills in the arts can readily understand other advantages and functions of the present inventive concept after reading the disclosure of this specification. Any changes or adjustments made to their relative relationships, without modifying the substantial technical contents, are also to be construed as within the range implementable by the present inventive concept.

Please refer to FIG. 1-1, FIG. 1-2 and FIG. 2. FIG. 1-1 is a schematic view of the external structure of the gearbox with flow guiding structure according to the present inventive concept. FIG. 1-2 is a structural cross-sectional view of direction A in FIG. 1-1. FIG. 2 is a schematic view of the gear set inside the gearbox with flow guiding structure according to the present inventive concept. The present inventive concept provides a gearbox with flow guiding structure, and the gearbox may comprise a box 1, an oil retaining wall 3 and an oil retaining ring 4. The box 1 may have a gear set configured thereinside, and the gear set may comprise a worm 21 and an epicyclic gear set 22 engaged with the worm 21. The oil retaining wall 3 may be disposed inside the box 1 and surrounding the epicyclic gear set 22. The oil retaining ring 4 may be disposed around the epicyclic gear set 22.

In detail, the epicyclic gear set 22 may comprise the worm gear 221, a sun gear 222, a plurality of outer gears 223 and a carrier 224, as shown in FIG. 1-2 and FIG. 2. The sun gear 222 may be coaxial with the worm gear 221. The worm gear 221 may be engaged with the worm 21. The carrier may have a center pillar 2241 and a plurality of peripheral pillars 2242 disposed around the center pillar 2241. The sun gear 222 and the plurality of outer gears 223 may be assembled on the carrier 224, so that the sun gear 222 may be engaged with the plurality of outer gears 223. The gearbox of according to the present inventive concept may be assembled in any suitable assembly sequence. In this exemplary embodiment of the present inventive concept, a plurality of outer gears 223 may be first assembled on the peripheral pillars 2242, and then the sun gear 222 and the worm gear 221 may be sleeved on the center pillar 2241 and stacked over the plurality of outer gears 223. The oil retaining ring 4 may be an annular gasket made of rubber. Therefore, when the sun gear 222 is sleeved on the center pillar 2241, it may be inserted into the center hole of the oil retaining ring 4. It can be seen in the cross-sectional structure shown in FIG. 1-2 that the oil retaining ring 4 is actually disposed around the coaxially disposed sun gear 222 and the worm gear 221 after assembly. The outer side wall of the oil retaining ring 4 has a curvature for blocking the lubricant among the sun gear 222, the worm gear 221 and the worm 21 above it. The curvature structure of the outer side wall of the oil retaining 4 may be shaped concave upward so as to guide the lubricant to circulate in the space among the sun gear 222, the worm gear 221 and the worm 21.

The box 1 can be further comprise an upper casing 11 and a lower casing 12 and the upper casing 11 and the lower casing 12 may be joined to each other to form the box 1. Please refer to FIG. 3 and FIG. 4. FIG. 3 is a structural schematic view of the upper casing. FIG. 4 is a structural schematic view of the lower casing. The specific structure of the oil retaining wall 3 of an exemplary embodiment of the present inventive concept is shown in FIG. 3. The oil retaining wall 3 may be an upright surrounding wall and annularly disposed to connect to the bottom of the upper casing 11. Moreover, an alignment groove 8 may be disposed at the bottom of the upper casing 11. When the upper casing 11 is engaged with the lower casing 12, the oil retaining wall 3 may be inserted into the inside of the lower casing 12 and surround the epicyclic gear set 22. The center pillar 2241 of the carrier 224 may abut against the alignment groove 8, thereby enhancing the stability of the epicyclic gear set 22 when rotating. The structure of the oil retaining wall 3 is used to block the lubricant that is thrown outward when the worm gear 221 and the sun gear 222 are rotating. The gap among the worm 21, the worm gear 221, and the sun gear 222 is reduced due to the closing characteristics when the upper casing and lower casing are engaged and the structural design of the oil retaining ring 3 in cooperation with the oil retaining ring 4.

In an exemplary embodiment of the present inventive concept, the upper edge of the inner side of the oil retaining wall 3 may have a curvature at the position connected to the upper casing 12. In another exemplary embodiment, the flow guiding structure inside the gearbox according to the present inventive concept can further comprise a first convex portion 5. The first convex portion 5 may be disposed at the bottom of the upper casing 11 and may be positioned on an inner side of the oil retaining wall 3. The curvature of the upper edge of the inner side of the oil retaining wall 3 may be shaped concave downward which is designed for enhancing the effect of reflow after the lubricant is thrown off by the gear set. The first convex portion 5 of the inner side of the oil retaining wall 3 may further enhance the oil retaining structure, so that the thrown lubricant would not flow above the worm gear 221 to reduce the use efficiency. The oil retaining wall 3, the oil retaining ring 4 and the first convex portion 5 may form a flow space for circulating a fluid. This effectively makes the flow range of the lubricant among the gears more controllable. The external force generated by the operation of the gear set (worm 21 and epicyclic gear set 22) causes the lubricant to circulate in this confined space. Even if the lubricant is thrown off, it will continue to flow back to the gap among the gear set, so that the lubricant can be used most effectively.

Please refer to FIG. 4 and FIG. 5. FIG. 5 is a schematic view of the gearbox combined with the motor. The box 1 may comprise a first space (not referenced in the figures) and a second space 102. The first space is used to accommodate the worm 21. The second space 102 is used to accommodate the epicyclic gear set 22. The box 1 may further comprise a partition wall 6 disposed in the first space inside the box 1. The first space may further comprise a first accommodating portion 101 and a second accommodating portion 103. The partition wall 6 may separate the first space to form the first accommodating portion 101 and the second accommodating portion 103. The worm 21 may be disposed in the first accommodating portion 101. The second accommodating portion 103 can be used to accommodate a fixing part 7. The external motor component may be connected to the box 1 through the fixing part 7 and may extend into the first accommodating portion 101 inside the box 1 to connect the worm 21. The fixing part 7 may be fixed to the second accommodating portion 103 by being embedded in the second accommodating portion 103. The motor component can be connected and fixed to the box 1 by means of the fixing part 7.

In summary, the present inventive concept provides a gearbox with flow guiding structure which comprises the structural configuration of the first convex portion, the oil retaining wall and the oil retaining ring around the gear set. The gearbox with flow guiding structure according to the present inventive concept is able to block the lubricant that is thrown off due to the rotation of the gear set. It guides the lubricant flow back to the gap among the gears. The structure of the inventive concept avoid the waste of lubricant thrown off by the gears during the high-speed rotation. The flow guiding structure inside the box according to the present inventive concept allows the lubricant to fully function and reduce the frictional resistance among the gears. In addition, the gearbox with flow guiding structure according to the present inventive concept can effectively reduce the heat caused by the high-speed rotation of the gear for about 8-10 degrees Celsius lower than the conventional gearbox.

The foregoing descriptions of the detailed embodiments are only illustrated to disclose the features and functions of the present inventive concept and not restrictive of the scope of the present inventive concept. It should be understood to those in the art that all modifications and variations according to the spirit and principle in the disclosure of the present inventive concept should fall within the scope of the appended claims.

What is claimed is:

1. A gearbox with flow guiding structure, comprising:
a box having a gear set configured inside, wherein the gear set comprises a worm and an epicyclic gear set engaged with the worm;
an oil retaining wall disposed inside the box and surrounding the epicyclic gear set; and
an oil retaining ring disposed around the epicyclic gear set, and the outer side wall of the oil retaining ring has a curvature.

2. The gearbox with flow guiding structure of claim 1, wherein the box comprises an upper casing and a lower casing, and the oil retaining wall is connected to the bottom of the upper casing.

3. The gearbox with flow guiding structure of claim 2, wherein the upper edge of an inner side of the oil retaining wall has a curvature at the position connected to the upper casing.

4. The gearbox with flow guiding structure of claim 2, wherein the box comprises a first space and a second space, the first space is used to accommodate the worm and the second space is used to accommodate the epicyclic gear set.

5. The gearbox with flow guiding structure of claim 4, wherein the box further comprises a partition wall and the first space comprises a first accommodating portion and a second accommodating portion, wherein the partition wall is disposed in the first space inside the box, and the partition wall separates the first space to form the first accommodating portion and the second accommodating portion.

6. The gearbox with flow guiding structure of claim 2, further comprising an alignment groove disposed at the bottom of the upper casing, wherein the alignment groove is in contact with some of the components of the epicyclic gear set.

7. The gearbox with flow guiding structure of claim 6, further comprising a first convex portion disposed at the bottom of the upper casing and around the alignment groove, and positioned on an inner side of the oil retaining wall.

8. The gearbox with flow guiding structure of claim 7, wherein the epicyclic gear set comprises the worm gear, a sun gear, a plurality of outer gears and a carrier, the sun gear is coaxial with the worm gear, the worm gear is engaged with the worm, the sun gear and the plurality of outer gears are assembled on the carrier and engaged with each other, and the oil retaining ring is surrounding the epicyclic gear set.

9. The gearbox with flow guiding structure of claim 8, wherein the carrier has a center pillar and a plurality of peripheral pillars disposed around the center pillar, the plurality of outer gears are respectively set on the peripheral pillars, the sun gear and the worm gear are set on the center pillar, and the center pillar is against the alignment groove when the upper casing is engaged with the lower casing.

10. The gearbox with flow guiding structure of claim 8, wherein the oil retaining wall, the oil retaining ring and the first convex portion form a flow space for circulating a fluid.

11. The gearbox with flow guiding structure of claim 1, wherein the oil retaining ring is an annular gasket made of rubber.
